(19) United States
(12) Patent Application Publication
(10) Pub. No.: US 2026/0177813 A1
(43) Pub. Date: Jun. 25, 2026

(54) Free-Form Surface Imaging Device Based on Light Customized Illumination and Free-Form Surface Design Method

(71) Applicants: Caihui New Materials (Hangzhou) Co., Ltd., Hangzhou City (CN); HLF HK CO., LIMITED, Kwun Tong (HK)

(72) Inventors: Mulin Wu, Hangzhou City (CN); Keran Bie, Hangzhou City (CN)

(21) Appl. No.: 19/056,450

(22) Filed: Feb. 18, 2025

(30) Foreign Application Priority Data
Dec. 25, 2024 (CN) 2024119206866

(51) Int. Cl. G02B 27/00; F21V 5/00

(52) U.S. Cl. CPC G02B 27/0012; F21V 5/00

(57) ABSTRACT

A free-form surface imaging device based on light customized illumination and a free-form surface design method are provided. The method includes the following steps: determining basic optical parameters and a target pattern, and sampling the incident plane and a focal plane; roughly matching incident light and emergent light of the lens to obtain a roughly matched light pair; calculating a surface normal vector of the lens surface by using Snell's law according to the roughly matched light pair; based on the surface normal vector, constructing an initial surface by Poisson equation; performing fine matching on the initial surface to obtain a finely matched light pair; and based on the finely matched light pair, carrying out a global and a local optimization by adopting a hierarchical optimization method to obtain design surface data of the free-form surface lens. The imaging device includes a light source and the free-form surface.

### CROSS-REFERENCE TO RELATED APPLICATIONS

This application claims priority to Chinese Patent Application No. 2024119206866, filed on Dec. 25, 2024, the contents of which are hereby incorporated by reference.

### TECHNICAL FIELD

The disclosure belongs to the technical field of customized illumination and particularly relates to a free-form surface imaging device based on light customized illumination and a free-form surface design method.

### BACKGROUND

Customized illumination is a technology that uses the processed light emitted by a light source to achieve the required illumination effect, such as road illumination and automobile illumination. In practical application, different light distribution may be needed to achieve different illumination effects. However, the direct application of light source usually may not meet the requirements. Adjusting the spatial energy distribution of light source efficiently is a research field of customized illumination, and also a classic and challenging problem in the field of non-imaging optics.

Because the radius of curvature is the only design freedom that conventional spherical surfaces may provide, customized illumination usually uses aspherical surfaces to redirect light beams. Aspheric optics may deal with rotating or linear symmetric illumination design very effectively, but due to the rotation or linear limitation of surface geometry, usually do not solve the asymmetric illumination problem well and may not meet growing demand for advanced illumination systems. Free-form surfaces are three-dimensional controllable optical surfaces, and free forms of the surfaces provide powerful degrees of freedom, which may be used to avoid restrictions on surface geometry and create compact and efficient designs with better performance. More importantly, using deformed surfaces may produce new designs that may not be achieved by using spherical or aspherical surfaces.

Although free-form surface may realize arbitrary customized illumination in theory, it is difficult to design because there is a great degree of freedom. Today's research is based on complicated mathematical derivation, but the exact solution has not been found, which limits the degree of freedom in practical design and is prone to no solution. In addition, methods are generally based on illumination design, which may not achieve accurate light level illumination. At the same time, today's design is not systematic and there is no clear design link.

### SUMMARY

The disclosure aims at solving the shortcomings of the prior art and provides following schemes.

A free-form surface imaging device based on light customized illumination, including a light source and a free-form surface lens, where the light source and the free-form surface lens are arranged separately, and light emitted by the light source is directly converged into a required customized pattern illumination through the free-form surface lens.

The disclosure also provides another free-form surface imaging device based on light customized illumination, including the light source and the free-form surface lens, where the light source is directly placed on the free-form surface lens, an incident plane of the free-form surface lens is a quasi-straight surface, and an emergent surface is a free surface.

The disclosure also provides a free-form surface design method for light customized illumination, where the design method is used for designing the free-form surface lens described in any one of the above, including the following steps:
determining basic optical parameters and a target pattern, and sampling the incident plane and a focal plane, where the optical parameters include a transmission refractive index, an emergent spatial refractive index, a focal plane position, a lens position and sampling number;
roughly matching incident light and emergent light of the lens to obtain a roughly matched light pair;
calculating a surface normal vector of the lens surface by using Snell's law according to the roughly matched light pair;
based on the surface normal vector, constructing an initial surface by Poisson equation;
performing fine matching on the initial surface to obtain a finely matched light pair; and

based on the finely matched light pair, carrying out a global and a local optimization by adopting a hierarchical optimization method to obtain design surface data of the free-form surface lens.

Optionally, a sampling method includes: adopting a concentric sampling:

$$( {l}^{2} - l - {N}_{0} \frac{{r}_{l}^{3} + {r}_{l} {r}_{1}}{S ( {r}_{l} - {r}_{1} )} ) \times \frac{π ( {r}_{l} - {r}_{1} )}{( {r}_{l} + {r}_{1} )} = 0$$

$$\{ \begin{matrix}{r}_{l} = max ( p - {p}_{0} ) \\ {r}_{1} = 2 \sqrt{\frac{S}{{N}_{0} π}}\end{matrix}$$

$$\frac{{r}_{n}}{l} = \frac{2 π {r}_{n}}{{c}_{n}} ( n > 1 , n ∈ {N}^{+} )$$

where l represents sampling radial rings number, N₀ represents ideal sampling number, S represents sampling pattern area, rₗ represents radius at an l-th ring outward from a center of a circle, r₁ represents radius at a first ring outward from the center of the circle, p represents a position of the free-form surface of the sampling pattern in coordinates of a rectangular coordinate system, p₀ represents a center of the pattern, rₙ represents radius of an n-th ring, cₙ represents sampling number of the n-th ring, and N⁺ represents a natural number set except 0.

Optionally, a method for obtaining the roughly matched light pair includes:
acquiring a point set X of the incident light and a point set T(X) of the emergent light; and
performing rough matching on the point set X and the point set T(X), finding a matching mapping in the point set T(X) to minimize a cost function, and obtaining the roughly matched light pair V and V′:

$${min}_{T} {\sum }_{X} {c}_{0} ( X , T ( X ) )$$

where c0(μ,ν) represents the cost function of rough matching.

Optionally, a method for calculating the surface normal vector includes:

$${V}^{′} = V + η N$$

$$η = \sqrt{{\tilde{n}}_{2}^{2} - {\tilde{n}}_{1}^{2} + {\tilde{n}}_{1}^{2} {cos}^{2} θ} - {\tilde{n}}_{1}^{2} cos θ$$

where V represents incident light of the roughly matched light pair, V′ represents emergent light of the roughly matched light pair, N represents the surface normal vector, ñ₁ represents the transmission refractive index, ñ₂ represents the emergent spatial refractive index, η represents a coefficient of a unit normal vector, and θ represents an incident angle.

Optionally, a method for constructing the initial surface includes:

carrying out a gradient solution on the surface normal vector, and solving a surface point cloud through Poisson equation:

$${∇}^{2} ϕ = Q$$

$$\partial ϕ / \partial n = H$$

$$H = grad ( ϕ ) \cdot N$$

where φ represents the surface point cloud, ∇ represents a divergence, grad represents a gradient, n represents a function normal vector, H represents a current solution value of an equation, and Q represents a value of a quadratic divergence; and
carrying out a vector displacement cycle on the surface point cloud to make a height of a surface center point equal to the position p of the free-form surface, ensuring a relative height of each surface point, and performing Poisson equation solution again until an error is within an error limit to obtain the initial surface;

$$e ( x , y ) = {‖ ϕ ( x , y ) - {ϕ}_{0} ( x , y ) ‖}_{2} > {e}_{0}$$

where e represents an error function, φ(x,y) represents a surface point cloud of a current cycle, φ₀(x,y) represents a surface function of a last cycle, and e₀ represents the error limit.

Optionally, a method for obtaining the finely matched light pair includes:
acquiring a point set X′ of the incident light and a point set T(X′) of the emergent light on the initial surface; and
performing fine matching on the point set X′ and the point set T(X′), finding a matching mapping in the point set T(X′) to minimize a cost function, and obtaining the finely matched light pair:

$${min}_{T} {\sum }_{{X}^{′}} c ( {X}^{′} , T ( {X}^{′} ) )$$

$$c ( u , ν ) = \int ( F ( u , ν ) + {c}_{0} ( u , ν ) ) d γ ( u , v )$$

where c(u,v) represents the cost function of fine matching, F(u,v) represents fine matching quantity, and γ(u,v) represents an integral domain mapping function.

Compared with the prior art, the disclosure may provide the following beneficial effects.

The disclosure optimizes the design of each parameter in an illumination system by introducing a numerical calculation, and at the same time, changes a structure of the cost function to make the cost function closer to the most natural light matching state. The method allows designers to adjust and optimize distribution and characteristics of light more flexibly without relying on conventional continuous mathematical conditions. Through the method provided by the disclosure, not only may more accurate illumination control be realized in complex geometric structures and multi-light source systems, but also an optimal solution may be explored under specific constraint conditions, thus effectively solving a problem of limited design freedom in conventional methods, thereby significantly improving the design flexibility and applicability of customized illumination systems and providing solid technical support and theoretical basis for realizing more efficient and intelligent illumination schemes.

By introducing a refractive index matrix, rewriting the fine matching cost function and not depending on a physical modeling of a numerical method, the disclosure may realize a customization of single light, independently adjust specific attributes of each light, and may realize precise control of a light propagation path for different light source situations, which may not only effectively reduce unnecessary light loss, but also avoid irregular distribution of light in space, thus providing more uniform and satisfying illumination effects in different application scenarios. Therefore, the precise control of the single light not only breaks through limitations of conventional illumination control, but also provides a new technical path for achieving higher quality and more efficient illumination effects.

By introducing systematic design ideas and optimization strategies, the disclosure puts forward a customized illumination design link of rough matching-initial structure-fine matching-multidimensional adaptive optimization. The universal design link may not only improve an efficiency of the customized illumination design, but also be popularized and used in different fields and applications, thus realizing modularization and standardization of an illumination system design. The disclosure contributes to systematization and standardization in a field of the customized illumination.

### BRIEF DESCRIPTION OF THE DRAWINGS

In order to explain the embodiments of the present disclosure or the technical schemes in the prior art more clearly, the drawings needed in the embodiments will be briefly introduced below. Apparently, the drawings in the following description are only some embodiments of the present disclosure. For one of ordinary skill in the art, other drawings may be obtained according to these drawings without paying creative labor.

FIG. 1 is a schematic structural diagram of an imaging device according to Embodiment 1 of the present disclosure.

FIG. 2 is a schematic structural diagram of an imaging device according to Embodiment 2 of the present disclosure.

FIG. 3 is a schematic flow chart of a method according to Embodiment 3 of the present disclosure.

FIG. 4 is a schematic diagram of a target pattern according to Embodiment 3 of the present disclosure.

FIG. 5 is a schematic diagram of a sampling situation according to Embodiment 3 of the present disclosure.

FIG. 6 is a schematic diagram of rough matching according to Embodiment 3 of the present disclosure.

FIG. 7 is a schematic diagram of an initial surface according to Embodiment 3 of the present disclosure.

FIG. 8 is a schematic diagram of a design result of a free-form surface according to Embodiment 3 of the present disclosure.

### DETAILED DESCRIPTION OF THE EMBODIMENTS

In the following, the technical schemes in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure clearer and easier to understand, the present disclosure will be further described in detail with the attached drawings and specific embodiments.

### Embodiment 1

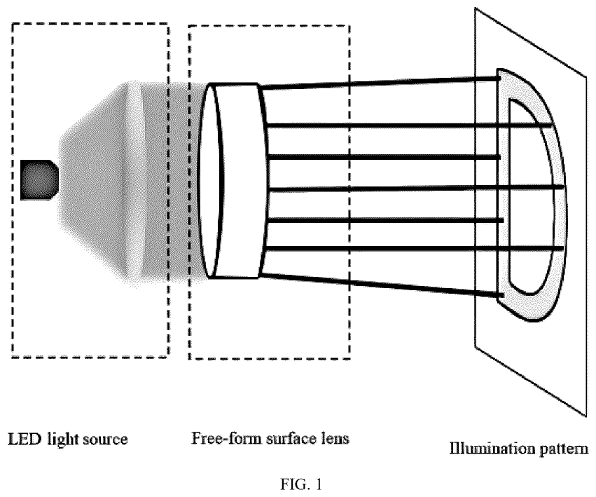

In this embodiment, an imaging device is provided, which includes a light source and a free-form surface lens, where the light source and the free-form surface lens are arranged separately. As shown in FIG. 1, light emitted by the light source is directly converged into a required customized pattern illumination through the free-form surface lens. The imaging device abandons a fragile, easy-to-pollute and low-light-energy-efficiency film pattern illumination mode, has advantages of a compact structure, a high light-energy utilization rate, firm leather, difficult damage and the like, and significantly improves product performance and competitiveness of the customized pattern illumination.

### Embodiment 2

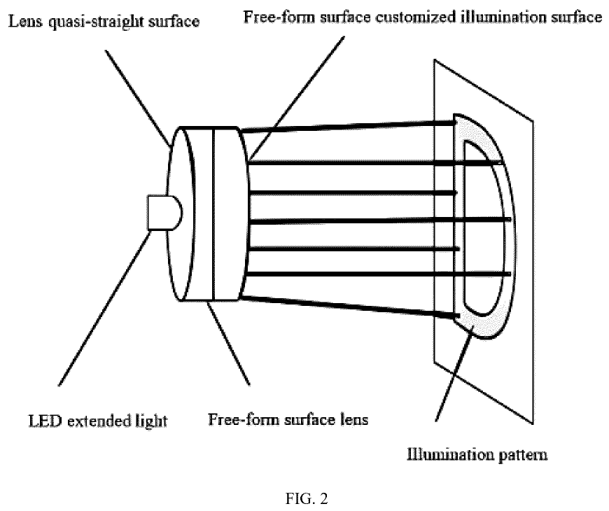

In this embodiment, an imaging device is provided, which includes a light source and a free-form surface lens, where the light source is directly placed on the free-form surface lens. As shown in FIG. 2, an incident plane of the free-form surface lens is a quasi-straight surface, and an emergent surface is a free surface. The imaging device directly uses LED to expand the light source, without a separate collimating lens. At the same time, the imaging device does not adopt a film pattern illumination mode, has advantages of a compact structure, a low space occupation rate, a high light-energy utilization rate, firm leather, difficult damage and the like, significantly improves product performance and a usage scene of a customized pattern illumination, reduces cost and increases competitiveness of the product.

### Embodiment 3

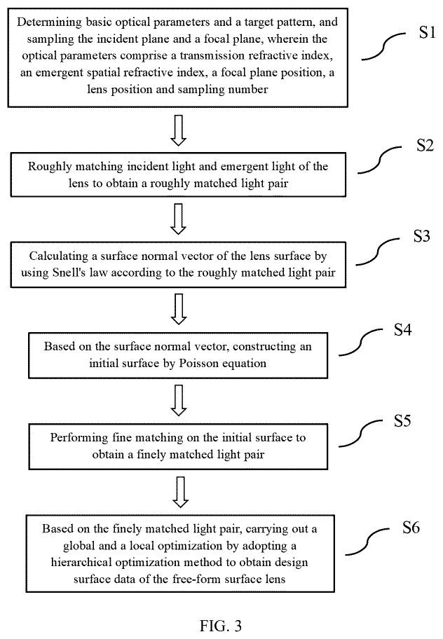

In this embodiment, as shown in FIG. 3, a free-form surface design method for light customized illumination includes the following steps.

S1. Determining basic optical parameters and a target pattern, and sampling the incident plane and a focal plane, where the optical parameters include a transmission refractive index, an emergent spatial refractive index, a focal plane position, a lens position and sampling number.

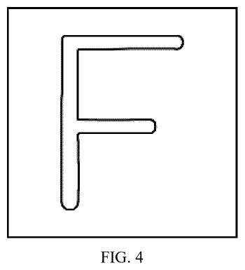

In this embodiment, the basic optical parameters include following parameters: the transmission refractive index ñ₁ is 1.5, the emergent spatial refractive index ñ₂ is 1, the focal plane position f is 130, a free-form surface position p is 30, a free-form surface aperture D is 50, and sampling number is 30000. The customized target pattern is shown in FIG. 4.

A sampling method includes following steps: in this embodiment, in order to ensure a circular shape suitable for the aperture and ensure an accurate design, a uniform concentric sampling is adopted:

$$( {l}^{2} - l - {N}_{0} \frac{{r}_{l}^{3} + {r}_{l} {r}_{1}}{s ( {r}_{l} - {r}_{1} )} ) \times \frac{π ( {r}_{l} - {r}_{1} )}{( {r}_{l} + {r}_{1} )} = 0$$

$$\{ \begin{matrix}{r}_{l} = max ( p - {p}_{0} ) \\ {r}_{1} = 2 \sqrt{\frac{S}{{n}_{0} π}}\end{matrix}$$

$$\frac{{r}_{n}}{l} = \frac{2 π {r}_{n}}{{c}_{n}} ( n > 1 , n ∈ {N}^{+} )$$

where l represents sampling radial rings number, N₀ represents ideal sampling number, S represents sampling pattern area, rₗ represents radius at an l-th ring outward from a center of a circle, r₁ represents radius at a first ring outward from the center of the circle, p represents a position of the free-form surface of the sampling pattern in coordinates of a rectangular coordinate system, p₀ represents a center of the pattern, rₙ represents radius of an n-th ring, cₙ represents sampling number of the n-th ring, and N⁺ represents a natural number set except 0. Solving the formula to get:

$$l = \frac{1 + \sqrt{1 + 4 {N}_{0} \frac{{r}_{l}^{3} + {r}_{l} {r}_{1}}{S ( {r}_{l} - {r}_{1} )}}}{2}$$

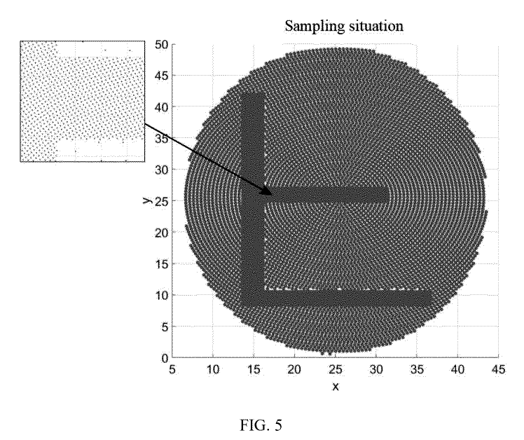

A sampling situation is shown in FIG. 5.

S2. Roughly matching incident light and emergent light of the lens to obtain a roughly matched light pair.

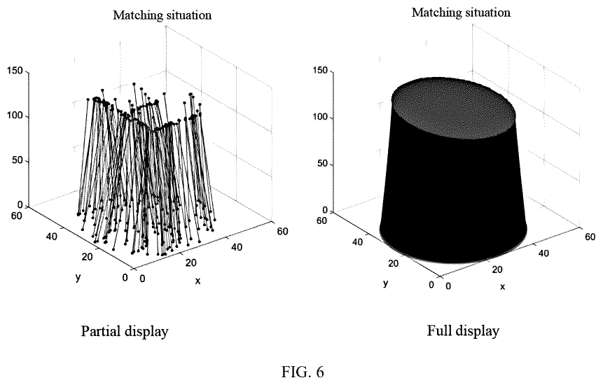

A method for obtaining the roughly matched light pair includes following steps: acquiring a point set X of the incident light and a point set T(X) of the emergent light; and performing rough matching on the point set X and the point set T(X), as shown in FIG. 6, finding a matching mapping in the point set T(X) to minimize a cost function, and obtaining the roughly matched light pair V and V′:

$${min}_{T} {\sum }_{X} {c}_{0} ( X , T ( X ) )$$

where c₀(μ,ν) represents the cost function of rough matching.

S3. Calculating a surface normal vector of the lens surface by using Snell's law according to the roughly matched light pair.

A method for calculating the surface normal vector includes:

$${V}^{′} = V + η N$$

$$η = \sqrt{{\tilde{n}}_{2}^{2} - {\tilde{n}}_{1}^{2} + {\tilde{n}}_{1}^{2} {cos}^{2} θ} - {\tilde{n}}_{1}^{2} cos θ$$

where V represents incident light of the roughly matched light pair, V′ represents emergent light of the roughly matched light pair, N represents the surface normal vector, ñ₁ represents the transmission refractive index, ñ₂ represents the emergent spatial refractive index, η represents a coefficient of a unit normal vector, and θ represents an incident angle.

S4. Based on the surface normal vector, constructing an initial surface by Poisson equation.

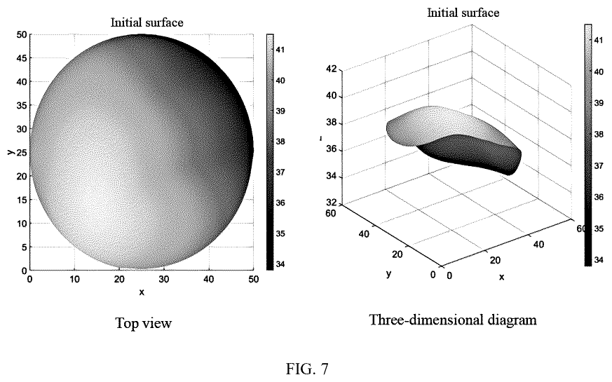

A method for constructing the initial surface includes: carrying out a gradient solution on the surface normal vector, and solving a surface point cloud through Poisson equation:

$${∇}^{2} ϕ = Q$$

$$\partial ϕ / \partial n = H$$

$$H = grad ( ϕ ) \cdot N$$

where φ represents the surface point cloud, ∇ represents a divergence, grad represents a gradient, n represents a function normal vector, H represents a current solution value of an equation, and Q represents a value of a quadratic divergence. When the surface normal vector N takes (x,y,−1), a horizontal axis component of the point cloud gradient is x, and a vertical axis component of the point cloud gradient is y, that is, φₓ=x and φ_{y}=y. Carrying out a vector displacement cycle on the surface point cloud to make a height of a surface center point equal to the position p of the free-form surface, ensuring a relative height of each surface point, and performing Poisson equation solution again until an error is within an error limit to obtain the initial surface, as shown in FIG. 7;

$$e ( x , y ) = {‖ ϕ ( x , y ) - {ϕ}_{0} ( x , y ) ‖}_{2} > {e}_{0}$$

where e represents an error function, φ(x,y) represents a surface point cloud of a current cycle, φ₀(x,y) represents a surface function of a last cycle, and e₀ represents the error limit. In this embodiment, e₀ takes 100.

S5. Performing fine matching on the initial surface to obtain a finely matched light pair.

A method for obtaining the finely matched light pair includes: acquiring a point set X′ of the incident light and a point set T(X′) of the emergent light on the initial surface; and performing fine matching on the point set X′ and the point set T(X′), finding a matching mapping in the point set T(X′) to minimize a cost function, and obtaining the finely matched light pair:

$${min}_{T} {\sum }_{{X}^{′}} c ( {X}^{′} , T ( {X}^{′} ) )$$

$$c ( u , ν ) = \int ( F ( u , ν ) + {c}_{0} ( u , ν ) ) d γ ( u , v )$$

where c(u,v) represents the cost function of fine matching, F(u,v) represents fine matching quantity, represents change amount of optical path difference of the lens, and includes supplementary operations customized for single light, such as reducing light intensity of a certain area, and γ(u,v) represents an integral domain mapping function.

S6. Based on the finely matched light pair, carrying out a global and a local optimization by adopting a hierarchical optimization method to obtain design surface data of the free-form surface lens.

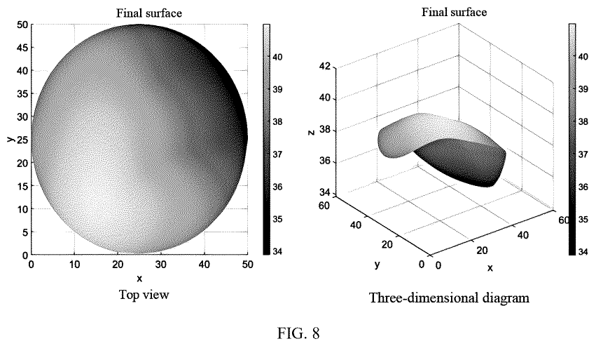

In this embodiment, an optimization operation is carried out according to the finely matched light pair, and the optimization is divided into inner and outer layers, with number of inner layers being 10 and number of outer layers being 10. The outer layers determine an optimized granularity, and a general granularity is from rough to fine, and from sampling 1000 to sampling 10000 respectively. A change of the granularity is shown in following formula:

$${J}_{n} = {J}_{0} {e}^{α t}$$

where Jn represents the change of the granularity, J₀ represents an initial sampling granularity, α represents a growth coefficient, and t represents number of cycles. For the outer layers, α=(ln Jₙ−ln J₀)/9, J₀=1000 and J₉=10000. For the inner layers, α=(ln Jₙ−ln J₀)/9, J0 depends on an error level when the sampling number is between 50 and 60, and J₉=0.001. After selecting the optimized granularity, a simulation operation is carried out according to Snell's law to get a result, and then an error value is obtained according to the target and the result. Then, the inner layers adopt adaptive error value classification to optimize a local alignment of selected blocks, where an error level of a region decreases with the change of Jn. Surface results obtained after optimization is shown in FIG. 8. The surface results are imported into Solidworks software. First, point cloud scanning is used to build a mesh, then a three-dimensional surface is reconstructed, and a three-dimensional model is established by a “stretching” operation in a three-dimensional drawing.

### Embodiment 4

According to a brand logo of a brand car, the free-form surface design method of the disclosure is adopted to design a microstructure on the free-form surface to make the free-form surface corresponding to the logo pattern, and then the free-form surface is combined with a light source to make a projection device, where the light source may be an LED light source. The projection device may be installed at or around headlights of a vehicle, or at a side of a door, etc., to form a welcome illumination effect, a reminder illumination effect, or other illumination effects.

### Embodiment 5

According to static plane advertisement design works, the free-form surface design method of the disclosure is adopted to design a microstructure on the free-form surface to make the free-form surface corresponding to the plane advertisement design works, and then the free-form surface is combined with a light source to make a projection device, where the light source may be an LED light source. The projection device may be installed in a lobby, an elevator room, and other public areas of buildings to form an advertising effect.

The above-mentioned embodiments only describe the preferred mode of the present disclosure, and do not limit the scope of the present disclosure. Under the premise of not departing from the design spirit of the present disclosure, various modifications and improvements made by ordinary technicians in the field to the technical schemes of the present disclosure should fall within the protection scope of the present disclosure.

1. (canceled)

2. (canceled)

3. A free-form surface design method for light customized illumination, comprising:
determining basic optical parameters and a target pattern, and sampling an incident plane and a focal plane, wherein the optical parameters comprise a transmission refractive index, an emergent spatial refractive index, a focal plane position, a lens position, and a sampling number;
roughly matching incident light and emergent light of the lens to obtain a roughly matched light pair;
calculating a surface normal vector of the lens surface by using Snell's law according to the roughly matched light pair;
based on the surface normal vector, constructing an initial surface by Poisson equation;
performing fine matching on the initial surface to obtain a finely matched light pair; and
based on the finely matched light pair, carrying out a global and a local optimization by adopting a hierarchical optimization method to obtain design surface data of a free-form surface lens;
wherein a sampling method comprises: adopting a concentric sampling:
wherein/represents sampling radial rings number, N₀ represents ideal sampling number, S represents sampling pattern area, rₗ represents radius at an l-th ring outward from a center of a circle, r₁ represents radius at a first ring outward from the center of the circle, p represents a position of the free-form surface of the sampling pattern in coordinates of a rectangular coordinate system, p₀ represents a center of the pattern, rₙ represents radius of an n-th ring, cₙ represents sampling number of the n-th ring, and N⁺ represents a natural number set except 0.

4. (canceled)

5. The free-form surface design method for light customized illumination according to claim 3, wherein a method for obtaining the roughly matched light pair comprises:
acquiring a point set X of the incident light and a point set T(X) of the emergent light; and
performing rough matching on the point set X and the point set T(X), finding a matching mapping in the point set (X) to minimize a cost function, and obtaining the roughly matched light pair V and V″:
$${min}_{T} {\sum }_{X} {c}_{0} ( X , T ( X ) )$$
wherein c₀(μ,ν) represents the cost function of rough matching.

6. The free-form surface design method for light customized illumination according to claim 5, wherein a method for calculating the surface normal vector comprises:
$${V}^{′} = V + η N$$
$$η = \sqrt{{\tilde{n}}_{2}^{2} - {\tilde{n}}_{1}^{2} + {\tilde{n}}_{1}^{2} {cos}^{2} θ} - {\tilde{n}}_{1}^{2} cos θ$$
wherein V represents incident light of the roughly matched light pair, V′ represents emergent light of the roughly matched light pair, N represents the surface normal vector, ñ₁ represents the transmission refractive index, ñ₂ represents the emergent spatial refractive index, η represents a coefficient of a unit normal vector, and θ represents an incident angle.

7. The free-form surface design method for light customized illumination according to claim 6, wherein a method for constructing the initial surface comprises:
carrying out a gradient solution on the surface normal vector, and solving a surface point cloud through Poisson equation:
$${∇}^{2} ϕ = Q$$
$$\partial ϕ / \partial n = H$$
$$H = grad ( ϕ ) \cdot N$$
wherein φ represents the surface point cloud, ∇ represents a divergence, grad represents a gradient, n represents a function normal vector, H represents a current solution value of an equation, and Q represents a value of a quadratic divergence; and
carrying out a vector displacement cycle on the surface point cloud to make a height of a surface center point equal to the position p of the free-form surface, ensuring a relative height of each surface point, and performing Poisson equation solution again until an error is within an error limit to obtain the initial surface;
$$e ( x , y ) = {‖ ϕ ( x , y ) - {ϕ}_{0} ( x , y ) ‖}_{2} > {e}_{0}$$
wherein e represents an error function, φ(x,y) represents a surface point cloud of a current cycle, φ₀(x,y) represents a surface function of a last cycle, and e₀ represents the error limit.

8. The free-form surface design method for light customized illumination according to claim 7, wherein a method for obtaining the finely matched light pair comprises:
acquiring a point set X′ of the incident light and a point set T(X′) of the emergent light on the initial surface; and
performing fine matching on the point set X′ and the point set T(X″), finding a matching mapping in the point set T(X′) to minimize a cost function, and obtaining the finely matched light pair:
$${min}_{T} {\sum }_{{X}^{′}} c ( {X}^{′} , T ( {X}^{′} ) )$$
$$c ( u , ν ) = \int ( F ( u , ν ) + {c}_{0} ( u , ν ) ) d γ ( u , v )$$
wherein c(μ,ν) represents the cost function of fine matching, F(u,v) represents fine matching quantity, and γ(u,v) represents an integral domain mapping function.
